(19) United States
(12) Patent Application Publication
(10) Pub. No.: US 2014/0240964 A1
(43) Pub. Date: Aug. 28, 2014

(54) ILLUMINATED MAKEUP MIRROR SET

(71) Applicants: PIONEER CORPORATION, Kawasaki-shi, Kanagawa (JP); LIGHTDESIGN INC., Tokyo (JP); TOHOKU PIONEER CORPORATION, Tendo-shi, Yamagata (JP)

(72) Inventors: Kazufumi Adachi, Kawasaki-shi (JP); Kazunaga Ida, Kawasaki-shi (JP); Taku Ito, Kawasaki-shi (JP); Harumi Nakamura, Kawasaki-shi (JP); Meiji Kitamura, Kawasaki-shi (JP); Takeshi Nakamura, Kawasaki-shi (JP); Yosuke Sato, Yonezawa (JP); Takuo Shinohara, Kawasaki-shi (JP); Hiroyasu Shoji, Tokyo (JP); Akane Kuroda, Tokyo (JP)

(21) Appl. No.: 14/347,557

(22) PCT Filed: Sep. 28, 2012
(86) PCT No.: PCT/JP2012/075151

§ 371 Date: Mar. 26, 2014

(30) Foreign Application Priority Data
Sep. 30, 2011 (JP) 2011-216737

(51) Int. Cl. F21V 33/00; F21K 99/00

(52) U.S. Cl. CPC F21V 33/004; F21K 9/58
USPC 362/141

(57) ABSTRACT

An illuminated makeup mirror set includes: a mirror unit having a mirror surface; side plates having attached thereto surface light sources with adjustable color; and a controller for driving the surface light sources according to an input operation and adjusting emission color and brightness of the surface light sources. The side plates are foldably connected to side edge portions of the mirror unit such that the angles between the mirror surface and the side plates are adjustable. Therefore, optimal illumination conditions can be produced, and the illuminated makeup mirror set can be easily carried.

### TECHNICAL FIELD

The present invention relates to an illuminated makeup mirror set including a mirror unit and a light source for illumination.

### BACKGROUND ART

When makeup (including hair styling) is put on a model or actress, illumination is necessary to clearly reflect the process of the makeup in a mirror. One known illumination light fixture is a so-called Hollywood light fixture including a plurality of light sources arranged in a row. An illuminated makeup mirror set including a makeup mirror and Hollywood light fixtures disposed on opposite sides of the makeup mirror has been commercially available as a makeup case. In these Hollywood light fixtures, the light sources used are generally incandescent lamps, which are point light sources.

Other known devices include: a device having illumination light sources disposed in at least one of the upper, lower, left, and right circumferential edges of a front mirror surface of a front mirror body of a three-way mirror (Patent Document 1); and a makeup unit having a makeup mirror and a lighting fixture with adjustable illumination characteristics (Patent Document 2). In the device in Patent Document 1, the light sources used are LED (light-emitting diode) point light sources. In the unit in Patent Document 2, RGB lamps are used so that emission color is changed.

### CITATION LIST

### Patent Documents

Patent Document 1: Japanese Patent Application Laid-Open No. 2008-272333

Patent Document 2: Japanese Patent Application Laid-Open No. 2009-125114

### SUMMARY OF THE INVENTION

### Problem to be Solved by the Invention

In the conventional illuminated makeup mirror set using Hollywood light fixtures, incandescent lamps are used as the light sources, as described above. Therefore, the size of the set is large, and it is inconvenient to carry the set. In addition, since the color of illumination cannot be changed, it is difficult to obtain optimal illumination conditions.

In the conventional illuminated makeup mirror set using point light sources such as LEDs or light bulbs, the point light sources are dazzling because the light therefrom directly enters the eyes, and this causes much pain when makeup takes a long time.

One example of problems to be solved by the present invention is the above-described drawback, and it is an object of the present invention to provide an illuminated makeup mirror set that produces optimal illumination conditions and is easily portable.

### Means to Solve the Problem

An illuminated makeup mirror set in an invention according to claim 1 comprises: a mirror unit having a mirror surface; a side plate having attached thereto a surface light source for illumination with adjustable color; and a controller for driving the surface light source according to an input operation and adjusting emission color and brightness of the surface light source, wherein the side plate is foldably connected to a side edge portion of the mirror unit such that an angle between the mirror surface and the side plate is adjustable.

An illuminated makeup mirror set in an invention according to claim 8 comprises: a mirror unit having a mirror surface; a side plate having attached thereto a surface light source for illumination with adjustable color; and a controller for driving the surface light source according to an input operation and adjusting emission color and brightness of the surface light source, wherein the side plate is connected to a side edge portion of the mirror unit and is slidable with respect to the mirror unit so as to overlap the mirror unit.

### BRIEF DESCRIPTION OF THE DRAWINGS

FIG. 1 is an external view of an illuminated makeup mirror set in an embodiment of the present invention.

FIG. 2 is a diagram illustrating a hinge mechanism in the makeup mirror set in FIG. 1.

FIG. 3 is an external view of the makeup mirror set in FIG. 1 in a folded state.

FIG. 4 is a cross-sectional view illustrating the structure of an organic EL panel in the makeup mirror set in FIG. 1.

FIG. 5 is a block diagram showing the configuration of a driving unit in the makeup mirror set in FIG. 1.

FIG. 6 is a diagram illustrating respective push buttons in an operation unit in the makeup mirror set in FIG. 1.

FIG. 7 is an external view of organic EL panels serving as mirror surfaces in the makeup mirror set in FIG. 1.

FIG. 8 is an external view of angle-adjustable organic EL panels in the makeup mirror set in FIG. 1.

FIG. 9 is an external view of an illuminated makeup mirror set including surface light sources and point light souses disposed on side plates.

FIG. 10 is an external view of an illuminated makeup mirror set including slide mechanisms.

FIG. 11 is an external view of an illuminated makeup mirror set including single surface light sources each having a light-emitting surface divided into a plurality of regions driven independently.

FIG. 12 is an external view of an illuminated makeup mirror set including surface light sources disposed on the left, right, and upper sides of the mirror.

### EMBODIMENTS

Embodiments of the present invention will next be described in detail with reference to the drawings.

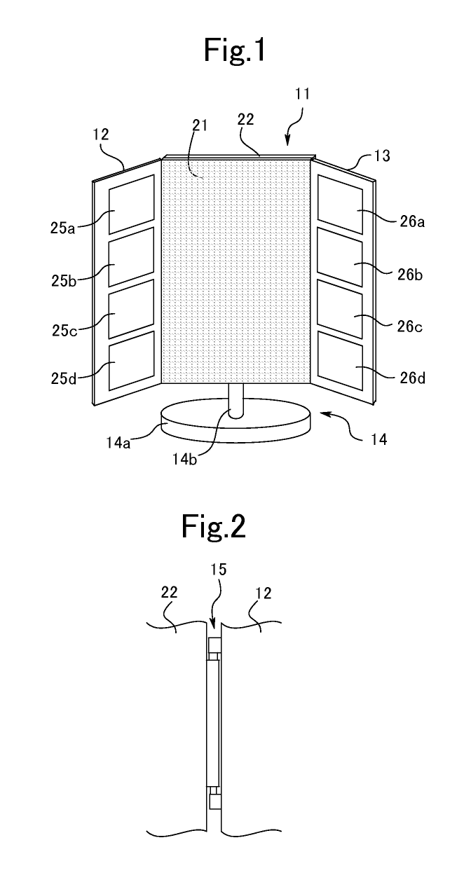

FIG. 1 shows an illuminated makeup mirror set, which is an embodiment of the invention according to claim 1. This makeup mirror set includes a mirror unit 11, left and right side plates 12 and 13, and a support 14. The mirror unit 11 includes a rectangular mirror 21 and a flat plate 22 affixed to the rear face of the mirror 21. The flat plate 22 is formed from a resin, wood, or a metal and may have the same size as the mirror 21 or may be slightly larger than the mirror 21. The left side plate 12 is connected to the left edge of the mirror unit 11 such that the angle therebetween is freely adjustable, and the right side plate 13 is connected to the right edge of the mirror unit 11 such that the angle therebetween is freely adjustable. A hinge mechanism 15 is formed between the mirror unit 11 and each of the side plates 12 and 13, as shown in FIG. 2, and these hinge mechanisms 15 allow the above connection angles to be freely adjustable. Each of these angles can be adjusted within the range of from an angle at which the mirror unit 11 and one of the side plates 12 and 13 are substantially flush with each other to an angle at which the one of the side plates 12 and 13 is folded with respect to the mirror unit 11.

The vertical length of each of the side plates 12 and 13 is the same as the vertical length of the mirror unit 11, but the horizontal length of each of the side plates 12 and 13 is equal to or less than ½ of the horizontal length of the mirror unit 11.

Four organic EL (Electro Luminescence) panels (surface light sources) 25a to 25d and four organic EL panels 26a to 26d are vertically arranged on and attached to the surfaces of the side plates 12 and 13, respectively. The organic EL panels 25a to 25d and 26a to 26d are identical and have a square shape of, for example, 13 cm×13 cm.

The support 14 includes an elliptical flat base 14a and a strut 14b, and the strut 14b is vertically connected to the base 14a. The strut 14b of the support 14 is detachably connected to the mirror unit 11 to support the mirror unit 11 including the side plates 12 and 13. For example, a connection hole (not shown) is formed in a lower portion of the mirror unit 11. The top portion of the strut 14b is inserted into the connection hole, and the support 14 is thereby connected to the mirror unit 11.

In the makeup mirror set in FIG. 1 having the above-described configuration, the user such as a makeup artist operates each of the side plates 12 and 13 with their joints to the mirror unit 11 (the hinge mechanisms 15) serving as rotation axes to thereby adjust the angles between the mirror unit 11 and each of the side plates 12 and 13. More specifically, the angles between the mirror unit 11 and each of the side plates 12 and 13 can be adjusted such that an image of a makeup subject such as a model that is reflected in the mirror surface of the mirror 21 is preferably illuminated with light emitted from the organic EL panels 25a to 25d and 26a to 26d on the side plates 12 and 13.

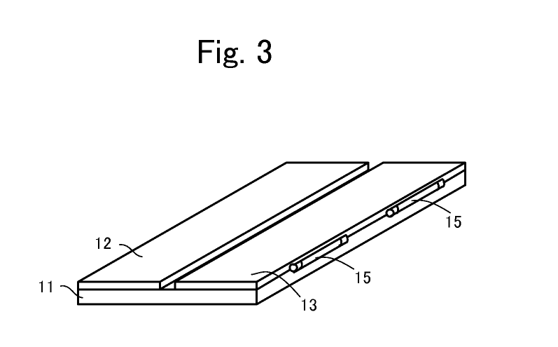

The side plates 12 and 13 can respectively be folded as shown in FIG. 3 with the organic EL panels 25a to 25d and 26a to 26d disposed thereon. In the folded state, the side plates 12 and 13 are not in contact with each other. Since the thickness of the organic EL panels 25a to 25d and 26a to 26d is small, the organic EL panels 25a to 25d and 26a to 26d do not come into pressure contact with the mirror 21.

The support 14 can be detached from the mirror unit 11 to separate the support 14 from the mirror unit 11 and the side plates 12 and 13. Then the side plates 12 and 13 can be folded with respect to the mirror unit 11 as described above, whereby the makeup mirror set can be easily conveyed.

Next, a description will be given of the organic EL panels 25a to 25d and 26a to 26d in the makeup mirror set in FIG. 1 and their driving system.

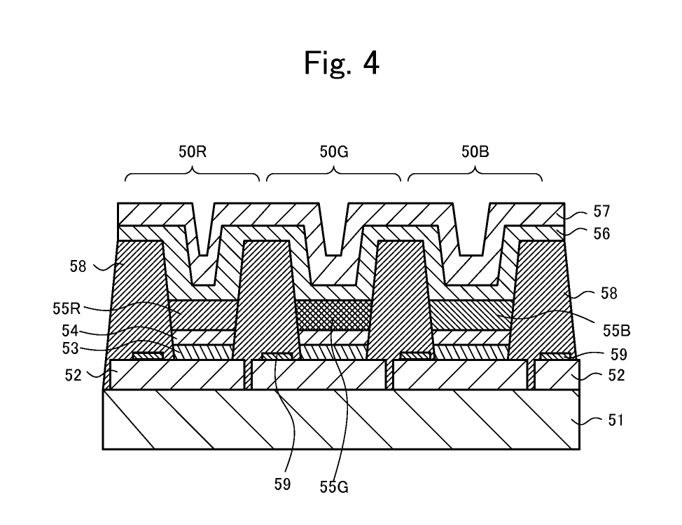

Each of the organic EL panels 25a to 25d and 26a to 26d is a full-color illumination light-emitting panel, and stripe-shaped organic EL elements 50R, 50G, and 50B with emission colors of R (red), G (green), and B (blue) are formed on a glass substrate 51, as shown in FIG. 4. In FIG. 4, a cross section in a direction orthogonal to the straight stripes is shown.

Each of the organic EL elements 50R, 50G, and 50B has a structure in which an anode 52, a hole injection layer 53, a hole transport layer 54, an RGB light-emitting layer 55R, 55G, or 55B, an electron transport layer 56, and a cathode 57 are stacked in that order. The organic EL elements 50R, 50G, and 50B are partitioned by banks 58. Bus lines 59 are formed on the anodes 52 of the respective organic EL elements 50R, 50G, and 50B, and the anodes 52 are energized through the bus lines 59. Each anode 52 is formed of, for example, an ITO film formed by sputtering and having a thickness of 70 nm. Each hole injection layer 53 is formed of CuPc and has a thickness of 20 nm. Each hole transport layer 54 is formed of NPB and has a thickness of 20 nm. Each R (red) light-emitting layer 55R is formed of CPB as a host material and Ir(phq)₂tpy as a dopant. Each G (green) light-emitting layer 55G is formed of CPB as a host material and Ir(ppy)₃ as a dopant, and each B (blue) light-emitting layer 55B is formed of PAND as a host material and DPAVBi as a dopant. The thicknesses of the RGB light-emitting layers 55R, 55G, and 55B are 40 nm. Each electron transport layer 56 is formed of CsxMoOx-doped NBphen and has a thickness of 30 nm. Each cathode 57 is formed of an Al film having a thickness of 70 to 100 nm. The internal structure of each of the organic EL panels 25a to 25d and 26a to 26d is only an example, and the present invention is not limited thereto.

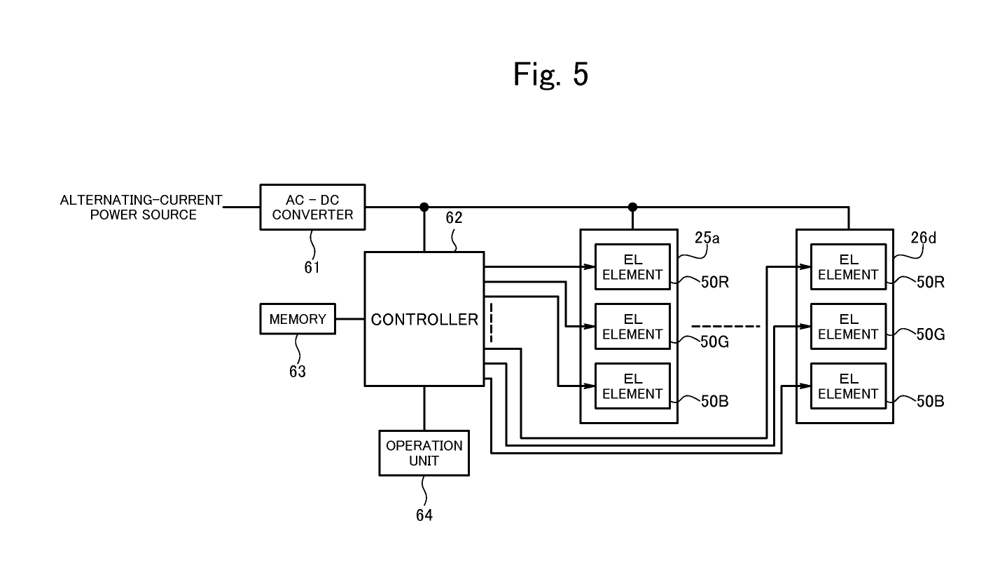

The makeup mirror set in FIG. 1 further includes a driving unit for driving the organic EL panels 25a to 25d and 26a to 26d. As shown in FIG. 5, the driving unit includes an AC-DC converter 61, a controller 62, a memory 63, and an operation unit 64. The AC-DC converter 61 converts alternating voltage to direct voltage and outputs the direct voltage. The output voltage from the AC-DC converter 61 is supplied as direct current power to the organic EL panels 25a to 25d and 26a to 26d and the controller 62. The controller 62 is operated by the output voltage from the AC-DC converter 61 as a power source and includes, for example, a CPU. The controller 62 controls the driving current for each of the RGB organic EL elements 50R, 50G, and 50B in the respective organic EL panels 25a to 25d and 26a to 26d to thereby control light emission (emission color and brightness) of each of the organic EL panels independently.

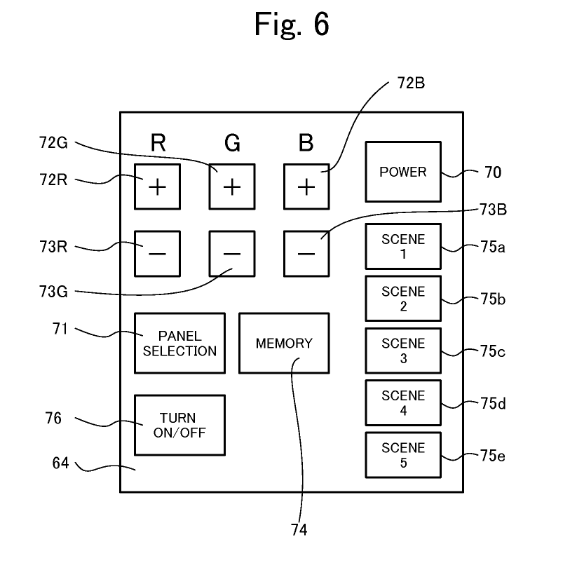

The memory 63 and the operation unit 64 are further connected to the controller 62. Programs and data necessary for the control by the controller 62 are stored in the memory 63. The operation unit 64 is provided as a wired or wireless remote controller and instructs the emission color and brightness of each of the organic EL panels 25a to 25d and 26a to 26d according to the input operation by the user. After the user operates a power button 70 in the operation unit 64 to turn the power on, the emission color and brightness of each of the organic EL panels 25a to 25d and 26a to 26d can be controlled independently according to the input operation by the user through the operation unit 64. The operation unit 64 includes, in addition to the power button 70, an organic EL panel selection button 71, R-level, G-level, and B-level increment buttons 72R, 72G, and 72B, and R-level, G-level, and B-level decrement buttons 73R, 73G, and 73B, a memory button 74, scene buttons 75a to 75e, and a turn on-off button 76, as shown in FIG. 6.

For example, one of the organic EL panels 25a to 25d and 26a to 26d is selected when the organic EL panel selection button 71 is pressed. Each time the organic EL panel selection button 71 is pressed, one of the organic EL panels 25a to 25d and 26a to 26d is selected in prescribed order. The RGB values (0 to 255) for the selected organic EL panel are adjusted by operating the increment buttons 72R, 72G, and 72B and the decrement buttons 73R, 73G, and 73B. When any of the increment buttons 72R, 72G, and 72B is pressed, the corresponding one of the RGB values increases. When any of the decrement buttons 73R, 73G, and 73B is pressed, the corresponding one of the RGB values decreases. When the increment button 72R or the decrement button 73R in the operation unit 64 is operated to change the R value, the controller 62 sets the driving current for the red-emitting organic EL elements 50R in the selected organic EL panel according to the R value and supplies the driving current to the red-emitting organic EL elements 50R. Similarly, when the increment button 72G or the decrement button 73G in the operation unit 64 is operated to change the G value, the driving current corresponding to the G value is supplied to the green-emitting organic EL elements 50G. When the increment button 72B or the decrement button 73B is operated to change the B value, the driving current corresponding to the B value is supplied to the blue-emitting organic EL elements 50B. The emission color and brightness of the selected organic EL panel can be set through the above operation. The emission color and brightness of the other organic EL panels can be set in a similar manner. By setting the emission color and brightness of each of the organic EL panels 25a to 25d and 26a to 26d in the manner described above, an illumination environment with a color corresponding to the scene of the activity of the makeup subject whose image is reflected in the mirror surface of the mirror 21 can be produced.

The relations between the RGB values and the driving currents are pre-stored as data in the memory 63, and the controller 62 reads the driving currents for the RGB values from the memory 63 and uses the values of the driving currents to drive the organic EL elements 50R, 50G, and 50B. An indicator for displaying the selected organic EL panel and the set RGB values may be provided in the operation unit 64 or the makeup mirror set body (any of the mirror unit 11 and the side plates 12 and 13).

When the memory button 74 is operated for a prescribed time or longer, the controller 62 writes the current RGB values of each of the organic EL panels 25a to 25d and 26a to 26d in the memory 63 as user-set data associated with the organic EL panels.

For each of a plurality of scenes, RGB values for each of the organic EL panels 25a to 25d and 26a to 26d are pre-stored as data in the memory 63. Examples of the scenes include an office, a hotel lounge, a dinner party, a fashion show, and an outdoor location. For each of the scenes, RGB values corresponding to the optimal emission color and brightness of each of the organic EL panels 25a to 25d and 26a to 26d are stored as data in the memory 63. The number of the scene buttons 75a to 75e provided is the same as the number of the plurality of scenes. When the scene button 75a, for example, is operated, the controller 62 reads the data of the scene corresponding to the scene button 75a (i.e., the RGB values for the organic EL panels 25a to 25d and 26a to 26d) from the memory 63. The controller 62 supplies driving currents to the RGB emitting organic EL elements 50R, 50G, and 50B in the organic EL panels 25a to 25d and 26a to 26d according to the read data. Therefore, when the scene button 75a is operated, illumination conditions suitable for the scene corresponding to the scene button 75a can be produced. The operation executed when one of the other scene buttons 75b to 75e is operated is the same as that for the scene button 75a.

When the memory button 74 is operated for a time shorter than a prescribed time, the controller 62 reads the user-set data from the memory 63 and supplies driving currents to the RGB emitting organic EL elements 50R, 50G, and 50B in the organic EL panels 25a to 25d and 26a to 26d according to the read data. Therefore, the illumination conditions preset by the user can be produced immediately through the operation of the memory button 74.

Before the turn on-off button 76 is operated, one of the organic EL panels 25a to 25d and 26a to 26d must be selected through the operation of the organic EL panel selection button 71. When the turn on-off button 76 is operated with one organic EL panel selected, the controller 62 reads a turn on-off flag for the one organic EL panel from the memory 63. When the turn on-off flag is 0 (initial value) representing “on,” the current RGB values of the one organic EL panel are written in the memory 63 as data immediately before the one organic EL panel is turned off, and the driving of each of the organic EL elements 50R, 50G, and 50B in the one organic EL panel is stopped. Then the turn on-off flag for the one organic EL panel in the memory 63 is changed to 1 representing “off.” More specifically, when the turn on-off button 76 is operated with the one organic EL panel turned on, no driving current flows into each of the organic EL elements 50R, 50G, and 50B in the one organic EL panel, and the one organic EL panel is turned off.

When the turn on-off button 76 is operated with the selected one organic EL panel turned off, the controller 62 reads the turn on-off flag for the one organic EL panel that represents 1 (corresponding to off) from the memory 63 and also reads the data of the one organic EL panel immediately before it was turned off from the memory 63. The controller 62 supplies driving currents to the RGB emitting organic EL elements 50R, 50G, and 50B in the one organic EL panel according to the read data of the one organic EL panel immediately before it was turned off and changes the turn on-off flag for the one organic EL panel in the memory 63 to 0 representing “on.” More specifically, when the turn on-off button 76 is operated with the one organic EL panel turned off (i.e., not emitting light), the driving currents used immediately before the one organic EL panel was turned off are supplied to the organic EL elements 50R, 50G, and 50B in the one organic EL panel, and the one organic EL panel resumes the turned-on (i.e., light-emitting) state immediately before it was turned off.

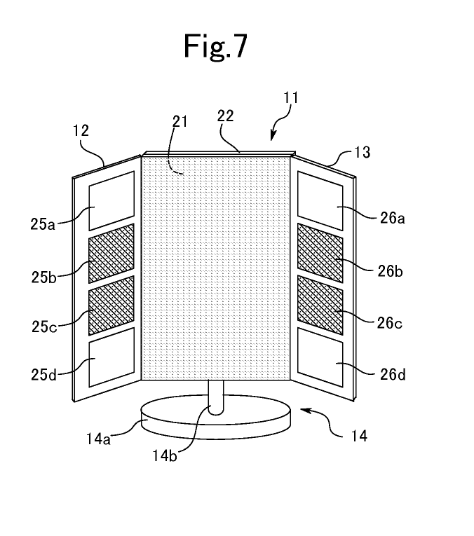

Each of the organic EL panels 25a to 25d and 26a to 26d in their turned-off state functions as a mirror surface because the Al film of the cathode 57 reflects light. In FIG. 7, the organic EL panels 25a, 25d, 26a, and 26d are turned on, and the organic EL panels 25b, 25c, 26b, and 26c are turned off, so that their light-emitting surface serves as a mirror surface. When part of or all the organic EL panels 25a to 25d and 26a to 26d are turned off to allow their light-emitting surface to serve as a mirror surface, the makeup mirror set can be used as a three-way mirror.

As described above, the illuminated makeup mirror set in the invention according to claim 1 includes a mirror unit having a mirror surface and side plates to which surface light sources for illumination with adjustable color are attached. Therefore, the makeup subject is not dazzled even when the intensity of the illumination provided is the same as that when point light sources are used, so that the makeup can be applied under good illumination conditions for a long time. In addition, since the surface light sources for illumination with adjustable color are provided, an illumination environment with a color corresponding to the scene of the activity of the makeup subject can be produced. Since the side plates are foldably connected to the side edge portions of the mirror unit such that the angles between the side plates and the mirror surface are adjustable, the image of the makeup subject can be clearly reflected in the mirror surface with no shade. When the side plates are folded with respect to the mirror unit, the makeup mirror set can be easily carried with the surface light sources attached.

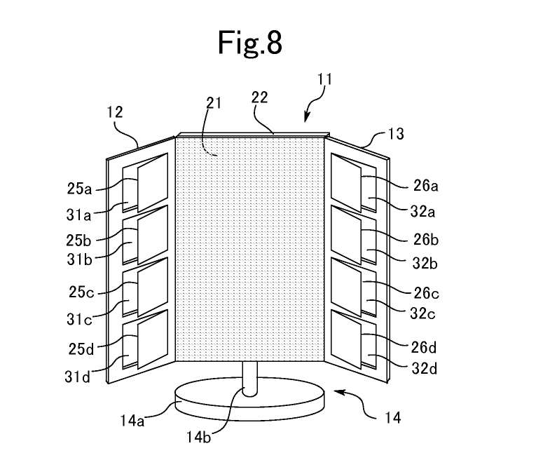

FIG. 8 shows an illuminated makeup mirror set in another embodiment of the present invention. In this makeup mirror set, the angles of the organic EL panels 25a to 25d and 26a to 26d with respect to the side plates 12 and 13 are adjustable. In the organic EL panels 25a to 25d and 26a to 26d, their edges close to the mirror unit 11 each serve as a rotation axis so that the angles of the organic EL panels 25a to 25d and 26a to 26d are adjustable. For example, the side plates 12 and 13 are connected to the organic EL panels 25a to 25d and 26a to 26d through hinge mechanisms (not shown) to allow the edges of the organic EL panels 25a to 25d and 26a to 26d close to the mirror unit 11 to serve as rotation axes. As shown in FIG. 8, openings 31a to 31d and 32a to 32d that can accommodate the organic EL panels 25a to 25d and 26a to 26d may be formed in the side plates 12 and 13 at positions corresponding to the organic EL panels 25a to 25d and 26a to 26d. When the angles of the organic EL panels 25a to 25d and 26a to 26d with respect to the side plates 12 and 13 are adjustable as described above, the angle of each of the organic EL panels can be freely adjusted, so that more suitable illumination conditions can be produced.

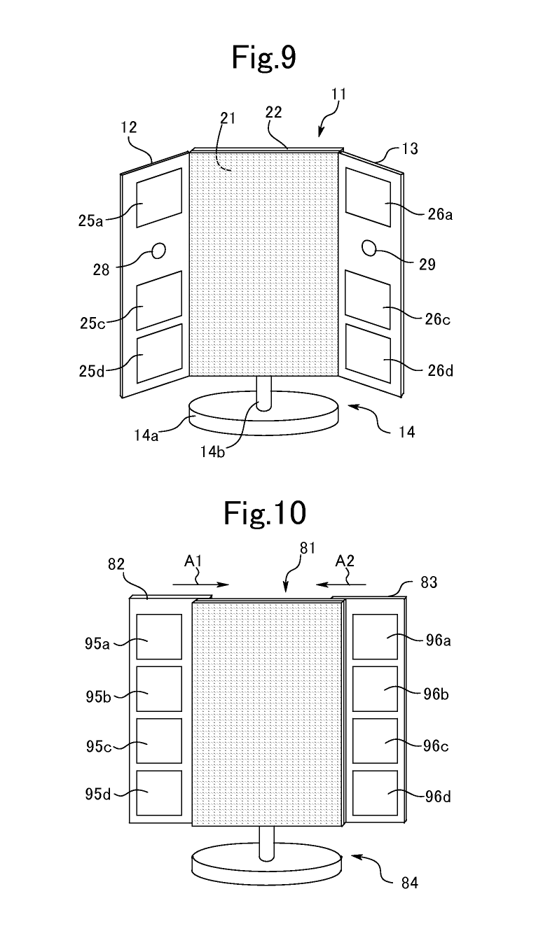

FIG. 9 shows an illuminated makeup mirror set in yet another embodiment of the present invention. In this makeup mirror set, point light sources 28 and 29, instead of the organic EL panels 25b and 26b in the makeup mirror set shown in FIG. 1, are attached to the side plates 12 and 13. LEDs (light-emitting diodes) may be used as the point light sources 28 and 29. When the point light sources 28 and 29 are embedded in the side plates 12 and 13 so that the side plates 12 and 13 can be folded, light bulbs may also be used as the point light sources 28 and 29. The use of the combination of the surface light sources and point light sources as described above allows the image of the makeup subject reflected in the mirror surface of the mirror 21 to be shaded. Each of the point light sources 28 and 29 may include, for example, a plurality of LEDs. A driving unit for supplying driving currents to the point light sources 28 and 29 may be provided separately from the driving unit for supplying driving currents to the organic EL panels 25a, 25c, 25d, 26a, 26c, and 26d.

In the embodiments described above, the RGB values for each of the organic EL panels are designated by the input operation by the user through the operation unit 64 to drive the color organic EL elements 50R, 50G, and 50B in the each of the organic EL panels 25a to 25d and 26a to 26d. However, the emission color and brightness of each of the organic EL panels may be designated by the input operation by the user through the operation unit 64. In this case, the RGB values are computed according to the emission color and brightness to drive the color organic EL elements 50R, 50G, and 50B in each of the organic EL panels 25a to 25d and 26a to 26d.

FIG. 10 shows an illuminated makeup mirror set, which is an embodiment of the invention according to claim 8. This makeup mirror set includes a mirror unit 81, left and right side plates 82 and 83, and a support 84. Organic EL panels 95a to 95d and 96a to 96d are attached to the side plates 82 and 83. The side plates 82 and 83 are connected to the left and right edge portions of the mirror unit 81 and are slidable with respect to the mirror unit 81 so as to overlap the mirror unit 81. Therefore, slide mechanisms (not shown) for allowing the side plates 82 and 83 to slide with respect to the mirror unit 81 are provided. The side plates 82 and 83 slide in directions indicated by arrows A1 and A2 shown in FIG. 10 according to the operation by the user and are housed on the rear side of the mirror unit 81, whereby the makeup mirror set is easily carried. The mirror unit 81, the left and right side plates 82 and 83, the support 84, and the organic EL panels 95a to 95d and 96a to 96d are the same as the mirror unit 11, the left and right side plates 12 and 13, the support 14, and the organic EL panels 25a to 25d and 26a to 26d in the makeup mirror set shown in FIG. 1 except that the hinge mechanisms 15 in FIG. 1 are replaced with the slide mechanisms to allow the side plates 82 and 83 to slide. In the illuminated makeup mirror set including the slide mechanisms described above, the angles of the side plates with respect to the mirror surface in the mirror unit 81 may be adjustable.

As described above, the illuminated makeup mirror set in the invention according to claim 8 includes a mirror unit having a mirror surface and side plates to which surface light sources for illumination with adjustable color are attached. Therefore, the makeup subject is not dazzled even when the intensity of the illumination provided is the same as that when point light sources are used, so that the makeup can be applied under good illumination conditions for a long time. In addition, since the surface light sources for illumination with adjustable color are provided, an illumination environment with a color corresponding to the scene of the activity of the makeup subject can be produced. The side plates are connected to the side edge portions of the mirror unit and are slidable with respect to the mirror unit so as to overlap the mirror unit. Therefore, in a state in which the side plates overlap the mirror unit, the makeup mirror set can be easily carried with the surface light sources attached.

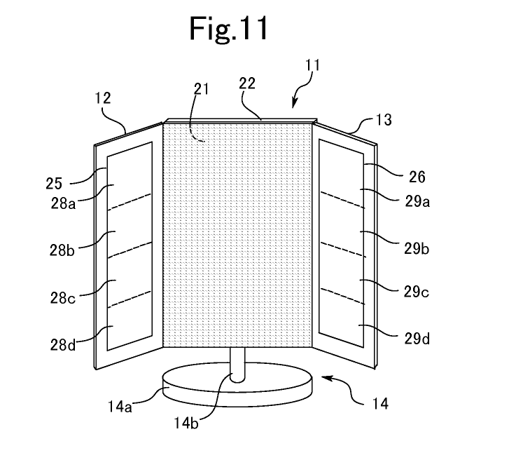

FIG. 11 shows an illuminated makeup mirror set including single surface light sources each having a light-emitting surface divided into a plurality of regions driven independently. For example, in the embodiment shown in FIG. 1, the plurality of organic EL panels 25a to 25d and 26a to 26d are attached to the side plates 12 and 13. However, as shown in FIG. 11, single elongated organic EL panels 25 and 26 may be attached to the side plates 12 and 13. In the illuminated makeup mirror set in FIG. 11, the light-emitting surface of each of the organic EL panels 25 and 26 is divided into a plurality of regions, e.g., four regions 28a to 28d or 29a to 29d, as shown by dotted lines in FIG. 11. The controller drives each of these regions according to the input operation by the user from the operation unit in the same manner as in the driving of each panel in the above-described embodiment, and the emission color and brightness of each region are adjusted.

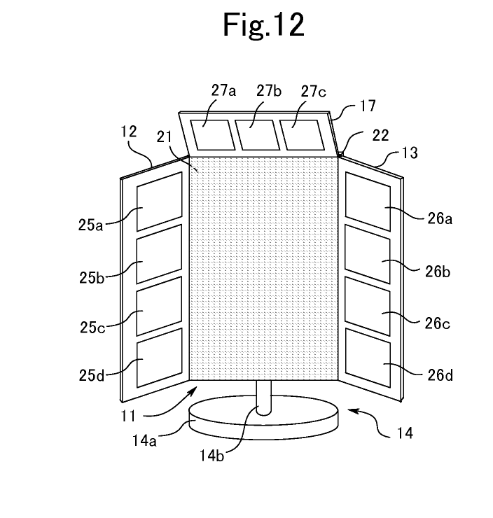

In each of the above-described embodiments of the present invention, the surface light sources are disposed on the left and right sides of the mirror surface of the mirror unit. However, another surface light source may be disposed above the mirror surface. For example, as shown in FIG. 12, in the makeup mirror set further including the surface light source disposed above the mirror surface, the left and right side plates 12 and 13 are connected to the mirror unit 11 such that the angles therebetween are adjustable. An upper plate 17 is connected to the upper portion of the mirror unit 11 such that the angle therebetween is adjustable, and three organic EL panels (surface light sources) 27a to 27c are horizontally arranged and attached to the upper plate 17.

### REFERENCE NUMERALS

11, 81 Mirror unit

12, 13, 82, 83 Side plate

14, 84 Support

15 Hinge mechanism

25, 26, 25a to 25d, 26a to 26d, 95a to 95d, 96a to 96d Organic EL panel

50R, 50G, 50B Organic EL element

1. An illuminated makeup minor set comprising:
a mirror unit having a mirror surface;
a side plate having attached thereto at least one surface light source for illumination with adjustable color; and
a controller for driving the at least one surface light source according to an input operation and adjusting emission color and brightness of the at least one surface light source,
wherein the side plate is foldably connected to a side edge portion of the mirror unit such that an angle between the mirror surface and the side plate is adjustable.

2. The illuminated makeup minor set according to claim 1, wherein the at least one surface light source is attached to the side plate, and light emission from the at least one surface light source is independently controllable.

3. The illuminated makeup minor set according to claim 1, wherein a light-emitting surface of the at least one surface light source serves as a minor surface when no light is emitted from the at least one surface light source.

4. The illuminated makeup minor set according to claim 1, wherein the at least one surface light source is attached to the side plate such that the angle therebetween is adjustable.

5. The illuminated makeup minor set according to claim 1, comprising a point light source disposed in the side plate.

6. The illuminated makeup minor set according to claim 1, wherein the side plate comprises a first side plate portion connected to a left edge portion of the mirror unit, and a second plate portion connection to a right edge portion of the mirror unit.

7. The illuminated makeup mirror set according to claim 1, comprising a support that supports the minor unit, the support being attachable to and detachable from the mirror unit.

8. An illuminated makeup mirror set comprising:
a mirror unit having a mirror surface;
a side plate having attached thereto a surface light source for illumination with adjustable color; and
a controller for driving the surface light source according to an input operation and adjusting emission color and brightness of the surface light source,
wherein the side plate is connected to a side edge portion of the minor unit and is slidable with respect to the minor unit so as to overlap the mirror unit.

9. An illumination set comprising:
a mirror surface;
a plurality of surface light sources; and
a controller configured to drive one or more of the plurality of surface light sources according to an input operation to adjust brightness of at least one of the plurality of surface light sources.

10. The illumination set according to claim 9, wherein an angle between the mirror surface and at least one of the plurality of surface light sources is adjustable.

11. The illumination set according to claim 9, further comprising a side plate attached to a side edge portion of the mirror surface.

12. The illumination set according to claim 11, further comprising a hinge mechanism that attaches the side plate to the side edge portion of the mirror surface.

13. The illumination set according to claim 12, wherein an angle between the minor surface and the side plate is adjustable.

14. The illumination set according to claim 11, wherein one or more of the plurality of surface light sources is disposed on the side plate.

15. An illumination set comprising:
a mirror;
a plurality of surface light sources; and
a controller configured to control one or more of the plurality of surface light sources between a first state and a second state,
wherein each of the plurality of surface light sources comprises a first electrode that is configured to reflect light and a second electrode,
the controller is configured to control at least one of the plurality of surface light sources to be in the first state and at least one other of the plurality of surface light sources to be in the second state, and
the first electrode of the at least one other surface light source in the second state serves as a reflective surface.

16. The illumination set according to claim 15, wherein the first electrode is a cathode and the second electrode is an anode.

17. The illumination set according to claim 15, wherein the controller is configured to control a subset of the plurality of surface light sources to be in the second state serving as a reflective surface.

18. The illumination set according to claim 17, wherein the first state is a turn-on state and the second state is a turn-off state.
